(19) United States
(12) Patent Application Publication
(10) Pub. No.: US 2008/0020265 A1
(43) Pub. Date: Jan. 24, 2008

(54) SIDEWALL TEMPERATURE CONTROL SYSTEMS AND METHODS AND IMPROVED ELECTROLYSIS CELLS RELATING TO SAME

(75) Inventors: Xinghua Liu, Murrysville, PA (US); Richard Beeler, Pittsburgh, PA (US); Thomas Hornack, Lower Burrell, PA (US); James Burg, Verona, PA (US); Steven Czekaj, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 11/750,865

(22) Filed: May 18, 2007

Related U.S. Application Data
(60) Provisional application No. 60/820,219, filed on Jul. 24, 2006.

(51) Int. Cl. H01M 10/44

(52) U.S. Cl. 429/50

(57) ABSTRACT

An electrolysis cell including an outer shell, a sidewall adjacent the outer shell and spaced therefrom, thereby defining a gap between the sidewall and the outer shell, and a plurality of fluid discharge devices interconnected about the outer shell, each of the plurality of fluid discharge devices extending from the outer shell towards the sidewall, wherein each of the plurality of fluid discharge devices is adapted to provide coolant to the sidewall. The plurality of fluid discharge devices may be individually controlled or controlled in sets to provide selective cooling to the sidewall, thereby facilitating ledge maintenance and profile.

### CROSS REFERENCE TO RELATED APPLICATION

This application claims priority to U.S. Provisional Application No. 60/820,219, filed Jul. 24, 2006, entitled “SIDEWALL TEMPERATURE CONTROL SYSTEMS AND METHODS AND IMPROVED ELECTROLYSIS CELLS RELATING TO SAME”, which is incorporated herein by reference in its entirety.

### FIELD OF THE INVENTION

The present invention relates to sidewall temperature control systems useful in electrolysis cells and associated methods for controlling the temperature of sidewalls in electrolysis cells. More particularly, the present invention relates to systems and methods for providing controlled flow of one or more coolants to the sidewalls of an electrolysis cell. The present invention also relates to improved electrolysis cells that may be utilized with such systems and methods.

### BACKGROUND OF THE INVENTION

A number of metals, including aluminum, lead, magnesium, zinc, zirconium, titanium, and silicon, can be produced by electrolytic processes. One example of an electrolytic process for metal production is the well-known Hall-Héroult process, in which alumina dissolved in a molten fluoride bath is electrolyzed at temperatures of about 900° C.-1000° C. to produce aluminum.

Traditional electrolytic cells include an outer containment shell and a sidewall lining designed to facilitate heat flow through the cell. During normal operation of the cell, a ledge of frozen liquid forms on this sidewall (e.g., a ledge of frozen cryolite in the case of aluminum electrolysis cells). The profile of this ledge plays an important role in the operation of the cell. If the ledge is too thin, the bath may attack the sidewalls of the tank, which may lead to failure of the cell. If the ledge is too thick, unstable cell operation may be witnessed. The ledge profile (e.g., the ledge thickness and extension under the anode) influences both the horizontal current and hydrodynamic behavior of the metal pad. Proper control of the ledge dynamic may assure electromagnetic stability of the cell.

Traditional aluminum electrolysis cells have been cooled via, for example, natural convention. Natural convection is undesirable in that, for instance, it is not controllable and thus proves difficult to maintain ledge stability, wastes energy and may lead to an unpleasant working environment.

Attempts have been made to try and control ledge stability using various systems. For example, many electrolytic cells employ a simple piping system within the sidewalls, wherein a coolant, such as air or helium, can be pumped through the pipes to facilitate controlled cooling of the sidewalls. U.S. Pat. No. 4,222,841 to Miller, U.S. Pat. No. 4,608,134 to Brown, U.S. Pat. No. 4,749,463 to Holmen, U.S. Pat. No. 4,865,701 to Beck et al., and U.S. Pat. No. 6,866,768 to Bradford et al. illustrate various examples of such cooling systems.

In another approach, phase-change materials may be utilized to facilitate cooling of sidewalls within the electrolytic cell. For example, U.S. Pat. No. 6,811,677 to Aune et al. discloses an electrolytic cell that includes a wall having an evaporative cooled panel. Aune et al. disclose that the evaporation cooled panels may contain a first panel, which contains a first cooling medium having a boiling point of between 850° C. and 950° C., and a second panel containing a second cooling medium, which acts to condense the evaporated first cooling medium. Aune et al. disclose that the second cooling medium may be pumped through the cell to a heat exchanger where the second cooling medium may be cooled with a third cooling medium.

As may be appreciated, there are several drawbacks to the above-described approaches. Primarily, many of such approaches are inefficient at maintaining a desired ledge profile, resulting in inefficient cell operation. Therefore, it is believed that none of the above-described systems have achieved commercial success. There exists a need for systems, apparatus and methods that can effectively maintain desired ledge profiles within an electrolytic cell.

### SUMMARY OF THE INVENTION

In view of the foregoing, a broad objective of the present invention is to provide apparatus, systems and methods adapted to maintain the profile of the ledge that forms during operations of an electrolytic cell. In addressing this objective, the present inventors have recognized that controlled cooling of various portions of the sidewalls of an electrolytic cell will facilitate the maintenance of the ledge profile. The present inventors have also recognized that dynamic and selective cooling of differing portions of the sidewall (e.g., cooling certain portions of the sidewall at a different rate than other portions of the sidewall) may facilitate the maintenance of the desired ledge profile.

More particularly, the present inventors have recognized that a plurality of fluid discharge devices may be utilized in conjunction with a sidewall and outer shell arrangement to selectively provide coolant to the sidewall. The present inventors have recognized that such an arrangement allows for the selective cooling of various portions of the sidewall, which facilitates ledge maintenance and profile.

In one aspect of the invention, an electrolysis cell is provided, the electrolysis cell having an outer shell, an internal sidewall proximal the outer shell and being spaced therefrom, thereby defining a gap between the sidewall and the outer shell, and a plurality of fluid discharge devices interconnected about the outer shell. The fluid discharge devices are generally adapted to discharge coolant towards at least a portion of the sidewall and at least one of the fluid discharge devices extends from the outer shell towards the sidewall. In one approach, at least one of the plurality of fluid discharge devices extends at least partially into the gap between the sidewall and the outer shell. In a particular embodiment, at least one of the fluid discharge devices is configured to discharge coolant at a selected trajectory, such as at a trajectory that is transverse to the inlet trajectory. In this regard, one or more of the plurality of fluid discharge devices may comprise a fingerlike shape. The fluid discharge devices may also be moveable to change the discharge trajectory of the coolant. In one embodiment, at least one of the fluid discharge devices is rotatable about an axis (e.g., a center axis) to facilitate the selected discharge trajectory.

The plurality of fluid discharge devices may include a first set of fluid discharge devices and a second set of fluid discharge devices, wherein the first set is disposed coincidental with a first plane, and wherein the second set is disposed coincidental with a second plane. Thus, the first set and second set of fluid discharge devices may be horizontally and/or vertically offset from one another. In this regard, the first and second planes may be substantially horizontal planes, may be substantially vertical planes and/or may not intersect.

The fluid discharge devices may be any devices adapted to facilitate the discharge of coolant therefrom. For instance, the fluid discharge devices may include one or more of a nozzle, a jet, a pipe, and mixtures thereof. In one embodiment, the fluid discharge devices are all nozzles. In another embodiment, the fluid discharge devices are all jets.

As noted, the electrolysis cell includes an outer shell and a sidewall. The outer shell and/or the sidewall may comprise tailored layers to facilitate more efficient operation of the electrolysis cell. For example, the outer shell may include one or more of a containment layer and an insulative layer. The containment layer is generally the outermost layer of the outer shell. The containment layer may be interconnected to the insulative layer and the containment layer may comprise a material adapted to contain molten materials. The insulative layer is generally disposed proximal the gap between the outer shell and sidewall, and thus the insulative layer restricts thermal communication between the sidewall and the outer shell. Hence, a substantial temperature difference between the sidewall and outer shell may be witnessed. Additionally, the exterior surface temperature of the outer shell may be significantly reduced relative to traditional electrolysis cells, which may provide a safer and more environmentally friendly working environment.

The sidewall of the inventive electrolysis cell may include at least one of a thermally conductive layer and a containment layer. The thermally conductive layer is generally disposed proximal the gap between the sidewall and the outer shell and comprises a thermally conductive material (e.g., a metal). The containment layer is generally disposed proximal the bath of the electrolysis cell and comprises a material adapted to contain molten materials during operation of the electrolysis cell, such as a refractory material.

In another aspect, an inventive electrolysis cell coolant system is provided, the system including an electrolysis cell, such as previously described, and a controller interconnected to one or more components of the electrolysis cell. The controller may be interconnected (e.g., electrically interconnected) to one or more sensory devices, one or more valves, and/or one or more of the fluid discharge devices, and the controller may be operable to control a coolant discharge parameter. In one approach, the coolant discharge parameter is a fluid discharge rate, wherein the controller is operable to control the fluid discharge rate of one of more of the plurality of fluid discharge devices. In one embodiment, the controller may receive signals from one or more sensory devices (e.g., one or more of a temperature sensor, a flow rate sensor, and/or a heat flux sensor) and the controller may send a signal to one or more valves to control the flow rate of coolant to the plurality of fluid discharge devices. In a related approach, the coolant discharge parameter is a fluid discharge direction (i.e., trajectory), wherein the controller is operable to control the fluid discharge direction of one or more of the plurality of fluid discharge devices. In one embodiment, the controller may receive signals from one or more sensory devices and send a signal to one of more of the fluid discharge devices, or a moveable device interconnected therewith, to move one of more of the fluid discharge devices, and thus change the fluid discharge direction.

The inventive system may include other features. For example, an inlet manifold may be fluidly interconnected to the fluid discharge devices and an outlet manifold may be fluidly interconnected to the gap between the sidewall and the outer shell. The inlet manifold may be interconnectable to a coolant supply and the outer shell may include passageways, integral therewith, that interconnect the inlet manifold to the plurality of fluid discharge devices. The plurality of passageways may extend partially or completely through the outer shell to interconnect the inlet manifold to the plurality of fluid discharge devices. The outlet manifold may also be interconnectable to at least one of a coolant disposal system and/or a coolant reclamation system (e.g., a heat exchanger). In this regard, an outlet passageway may be included in the outer shell to fluidly interconnect the gap with the outlet manifold. In one approach, a plurality of outlet passageways may be utilized to interconnect the gap with the outlet manifold. In another approach, the outer shell may simply include an exit passageway that allows fluid within the gap to exit the gap without the use of an outlet manifold.

In another aspect of the present invention, an inventive method for cooling an electrolysis cell is provided. The method generally includes the steps of passing coolant through a fluid discharge device and contacting at least a portion of a sidewall of the electrolysis cell with the coolant. The method may include the step of discharging the coolant through at least one fluid discharge device at a selected discharge trajectory/direction. For instance, the coolant may be discharged from the outlet of the fluid discharge device at a trajectory that is transverse to the inlet trajectory of the coolant entering the inlet of the fluid discharge device. The method may also include the step of changing the discharge trajectory, such as by moving the fluid discharge device. In one embodiment, the fluid discharge device is rotated about an axis to change the fluid discharge trajectory/direction. To facilitate the changing step, the method may include the step of sending a signal from a controller, such as previously described, to the fluid discharge device. The method may also include the steps of measuring an operation parameter of the electrolysis cell and completing an action (e.g., a predetermined response) in response to the measuring step. For instance, the controller may measure an operation parameter, such as via a sensory device, and either change a coolant flow rate or change a position of a fluid discharge device.

These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 is a cross-sectional, side view of one embodiment of an electrolytic cell useful in accordance with the present invention.

FIG. 2 is a side, cross-sectional view of a portion of FIG. 1 illustrating one sidewall, outer shell, fluid discharge device arrangement.

FIG. 3 is a schematic view of one control arrangement useful in accordance with the present invention.

FIG. 4a is one embodiment of a fluid discharge device arrangement useful in accordance with the present invention.

FIG. 4b is another embodiment of a fluid discharge device arrangement useful in accordance with the present invention.

FIG. 5 is a top view of a portion of the electrolytic cell of FIG. 1.

FIG. 6a is a top, cross-sectional view of a portion of FIG. 1, corresponding with a first plane of the electrolytic cell.

FIG. 6b is a top, cross-sectional view of another portion of FIG. 1, corresponding with a second plane of the electrolytic cell.

FIG. 7 is cross-sectional view of the sidewall, outer shell, fluid discharge device arrangement of FIG. 1.

FIG. 8 is a side view of the electrolytic cell of FIG. 1, illustrating one embodiment of a manifold interconnection arrangement.

FIG. 9 is a schematic view of one embodiment of a manifold interconnection arrangement useful in accordance with the present invention.

FIG. 10a is a schematic view of one embodiment of methods useful in cooling sidewalls of electrolysis cells in accordance with the present invention.

FIG. 10b is a schematic view of one embodiment of methods useful in cooling sidewalls of electrolysis cells in accordance with the present invention.

### DETAILED DESCRIPTION

Reference will now be made to the accompanying drawings, which at least assist in illustrating various pertinent features of the present invention.

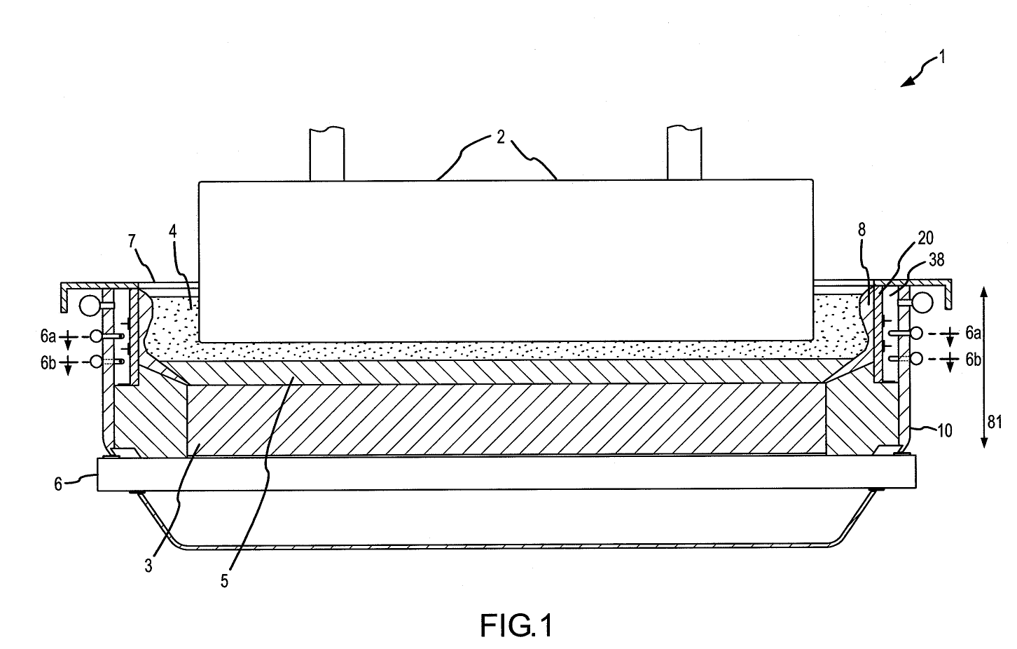

FIG. 1 illustrates an electrolytic aluminum production cell useful in accordance with the present invention. The electrolytic cell 1 includes an outer shell 10, an anode 2, a cathode 3, a current collector 6 interconnected to the cathode 3, and a top 7. A sidewall 20 is disposed adjacent the outer shell 10 and is spaced therefrom, thereby creating a gap 38 between the outer shell 10 and the sidewall 20. In operation, electric current is passed from the anode 2, through a molten electrolyte bath 4, thereby reducing a metal oxide (e.g., alumina) contained in the bath 4 to a molten metal 5 (e.g., aluminum). A ledge 8 of frozen electrolyte (e.g., cryolite) forms during operation of the cell. The formation of the ledge 8 and the ledge's profile is facilitated via the supply of coolant to the sidewall 20.

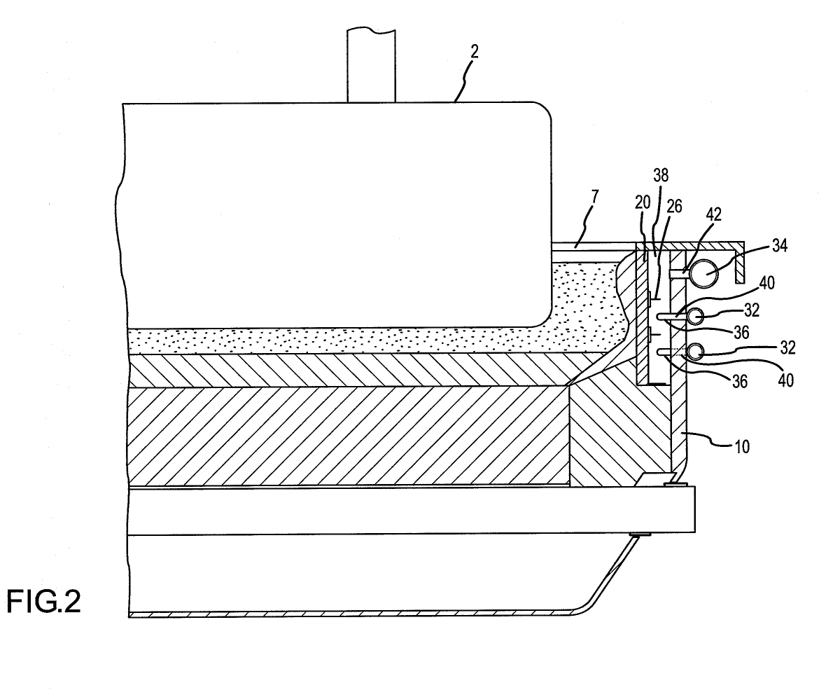

More particularly and with reference to FIG. 2, a coolant (e.g., air, helium, or other suitable gas or liquid) is supplied to exterior surfaces of the sidewall 20 via one or more fluid discharge devices 36. In the illustrated embodiment, the fluid discharge devices are one or more nozzles 36 (“nozzle(s)”). The nozzle(s) 36 are interconnectable to a coolant supply system (not shown) via inlet manifold 32 and passageways 40 (e.g., fluid inlets). The nozzle(s) 36 generally extend from the outer shell 10 toward the sidewall 20. During operation of the electrolytic cell 1, coolant may be selectively supplied to the nozzle(s) 36 for discharge therefrom to cool selected surfaces of the sidewall 20. In this regard, a suitable control system or controller, discussed in further detail below, may be interconnected to the nozzle(s) 36 and/or associated valve(s) (not illustrated) for controlling the supply of coolant to the sidewall 20 from the nozzle(s) 36. The discharged coolant from the nozzle(s) 36 passes through at least a portion of gap 38 before contacting sidewall 20, thereby cooling the sidewall 20 (e.g., via convection and/or conduction). Spent coolant may be collected via outlet manifold 34, which is fluidly interconnectable to gap 38 via a passageway 42 and/or a valve (not illustrated). Thus, the profile (e.g., thickness and/or height) of the ledge 8 may be controlled via selective supply of coolant to desired portions of the sidewall 20 via the nozzle(s) 36.

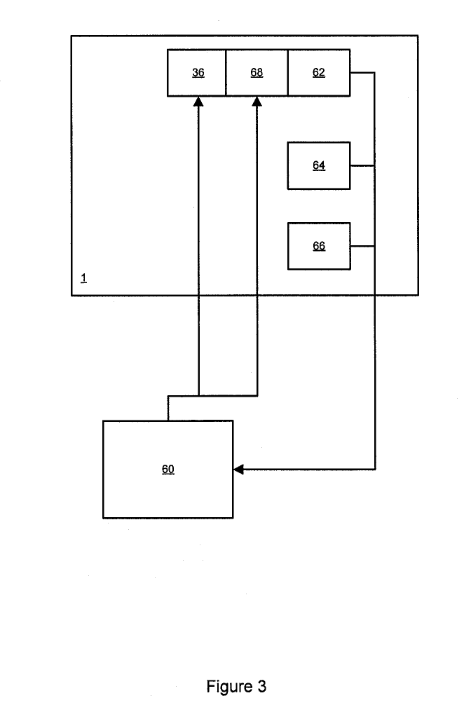

To facilitate selective control of the ledge 8 profile, it may be desirable to employ a controller to control the discharge of coolant from the nozzle(s) 36. One embodiment of a control arrangement is schematically illustrated in FIG. 3. In this arrangement, the controller 60 is interconnected to the nozzle(s) 36 (e.g., electrically interconnected), such as via a one or more valves 68 (“valve(s)”). The controller 60 may also be interconnected to one or more sensory devices, such as one or more coolant flow meters 62 (“flow meter(s)”), one or more temperature sensors 64 (“temperature sensor(s)”) and/or one or more heat flux meters 66 (“heat flux meter(s)”). As discussed in further detail below, the controller 60 may utilize information/data provided by the sensory devices to control the discharge rate of coolant from the nozzle(s) 36, thereby facilitating selective temperature control of various portions of the sidewall 20, and thus selective control of ledge 8 profile.

The nozzle(s) 36 and sensory devices may be disposed within the electrolytic cell 1 at any suitable location(s). In a particular embodiment, the nozzle(s) 36 are partially disposed within the gap 38, as illustrated in FIG. 2, and the flow meter(s) 62 may be disposed in each of the passageways 40 for measuring the flow rate of coolant provided to each of the nozzle(s) 36. In another embodiment, the flow meter(s) 62 may be disposed within the inlet manifold 34 for measuring the flow rate of coolant provided to the nozzle(s) 36. The controller 60 may receive signals/data from the flow meter(s) 62 and, in response, determine amounts of coolant being supplied to each of the nozzle(s) 36. The flow meter(s) 62 may be any flow meters adapted for use in an electrolytic cell environment, such as a digital flow meter.

Temperature sensor(s) 64 may be disposed within the electrolytic cell 1. In one embodiment, the temperature sensor(s) 64 may be disposed within the gap 38 for measuring the temperature of the fluids located therein (e.g., air within the gap 38). The controller 60 may receive signals/data from the temperature sensor(s) 64 and, in response, determine the temperature of one or more portions of the sidewall 20. For example, the controller 60 may receive temperature measurements associated with lower, middle and/or upper portions of the sidewall 20. The temperature sensor(s) 64 may be any temperature sensors adapted for use in an electrolytic cell environment, such as a thermocouple.

Heat flux meter(s) 66 may be disposed within the electrolytic cell 1. In one embodiment, the heat flux meter(s) may be interconnected to various portions of the sidewall 20 for measuring the heat flux of such portions of the sidewall 20, The controller 60 may receive signals/data from the heat flux meter(s) 66 and, in response, determine the heat flux of one or more portions of the sidewall 20. For example, the controller 60 may receive heat flux measurements associated with lower, middle, and/or upper portions of the sidewall 20. The heat flux meter(s) 62 may be any heat flux meter(s) adapted for use in an electrolytic cell environment, such as a HT-50 thermal flux sensor available from International Thermal Instrument Company, Del Mar, Calif.

The controller 60 may utilize the information/data from the sensory devices to achieve the desired the cooling rates. In this regard, the controller 60 may be a computerized device (e.g., a general purpose computer) and may utilize one or more of a temperature measurement, flow rate measurement, and/or heat flux measurement to determine an appropriate control response. For example, the controller 60 may determine (e.g., calculate via a digital processor) that the temperature within a portion of the electrolytic cell 1 is relatively high and/or determine that the heat flux associated with a portion of the sidewall 20 is relatively low. In turn, the controller 60 may send an appropriate signal to valve(s) 68 interconnected to the nozzle(s) 36 to increase coolant flow rates to the nozzle(s) 36, thereby increasing the cooling rate associated with those portions of the sidewall 20. In another instance, the controller 60 may determine that the temperature within a portion of the electrolytic cell 1 is relatively low and/or determine that the heat flux associated with a portion of the sidewall 20 is relatively high. In turn, the controller 60 may send an appropriate signal to valve(s) 68 interconnected to the nozzle(s) 36 to decrease coolant flow rates to the nozzle(s) 36, thereby decreasing the cooling rate associated with those portions of the sidewall 20.

The coolant discharge rate from the nozzle(s) 36 may be controlled individually, in sets, or globally by the controller 60 to achieve the desired cooling rates. For example, the controller 60 may selectively control individual nozzle(s) 36 to achieve the desired cooling rates (e.g., via valves located within the nozzle(s) 36, the flow meter(s) 62, and/or the passageway(s) 40). In one embodiment, the controller 60 may be adapted to provide analog-like control of the coolant flow rate, thereby selectively tailoring coolant flow to the nozzle(s) 36, and possibly over a wide range of coolant flow rates. This analog-like control may be accomplished, for example, by moving a valve position between, and sometimes from, various open and closed configurations. In an alternate embodiment, the controller 60 may be adapted to turn coolant flow on and off, in essence providing digital-like control of individual nozzle(s) 36 (e.g., via opening and closing of a valve). As discussed in further detail below, the controller 60 may also/alternatively be interconnected to the nozzle(s) 36 to control the discharge trajectory of the coolant to facilitate selective cooling of various portions of the sidewall 20. The controller 60 may control the nozzle(s) 36 in sets, such as a first and second set of nozzles, to achieve the desired cooling, such as by simultaneously coordinating flow rates and positions associated with a certain set(s) of nozzles. The controller 60 may control individual nozzles in serial or parallel and/or the controller 60 may control sets of nozzles in serial or in parallel.

Any suitable number of nozzle(s) 36 may be employed in accordance with the present invention. The number of nozzle(s) 36 employed in an electrolytic cell 1 is a function of many variables, including, by way of example, coolant delivery rate per nozzle, cell operating temperature, cell size, coolant type and nozzle spacing.

The nozzle(s) 36 may be any suitable nozzles adapted to deliver fluid coolant to sidewalls of an electrolysis cell. In this regard, the nozzle(s) 36 should be resistant to oxidation and should function in relatively high temperatures (e.g., 500° C.-1100° C.). For example, the nozzle(s) 36 may include one or more stainless steel materials. Suitable nozzles include air nozzles produced by, for example, AiRTX, Cincinnati, Ohio, United States of America; EXAIR, Cincinnati, Ohio, United States of America; SILVENT, Bor\dot{a}s, Sweden; and Spraying Systems Co., Carol Stream, Ill., United States of America, to name a few.

The nozzle(s) 36 should be adapted to provide coolant to the sidewall 20 at desired flow rates to achieve desired cooling rates. The desired flow rate is generally dependent upon many variables, including cell operating temperature, nozzle number and spacing, coolant type, and cell size, to name a few. For example, nozzles adapted to provide air to the sidewall of an aluminum electrolysis cell may have the ability to provide between 0-50 SCFM or even 0-100 SCFM of air.

The nozzle(s) 36 may be adapted to discharge the coolant in any desired pattern and any desired trajectory. For example, the nozzle(s) 36 may be adapted to discharge coolant in a flat, substantially planar discharge pattern. Alternatively, the nozzle(s) 36 may be adapted to discharge coolant in a non-planar pattern, such as a cone pattern.

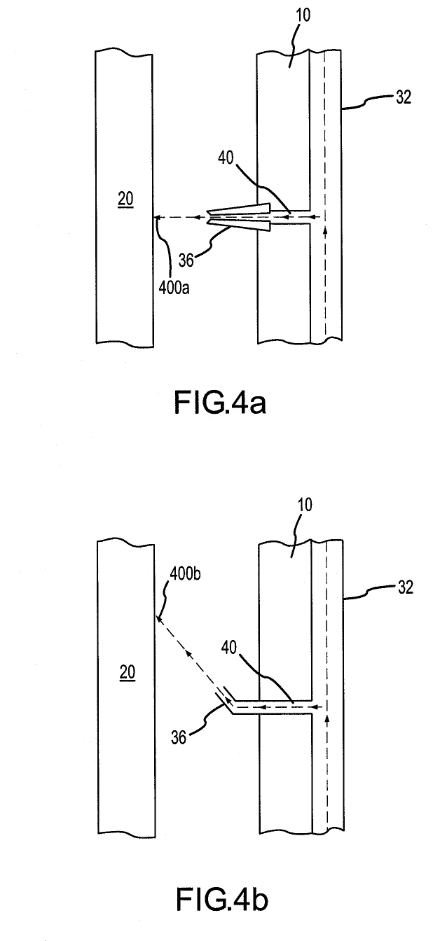

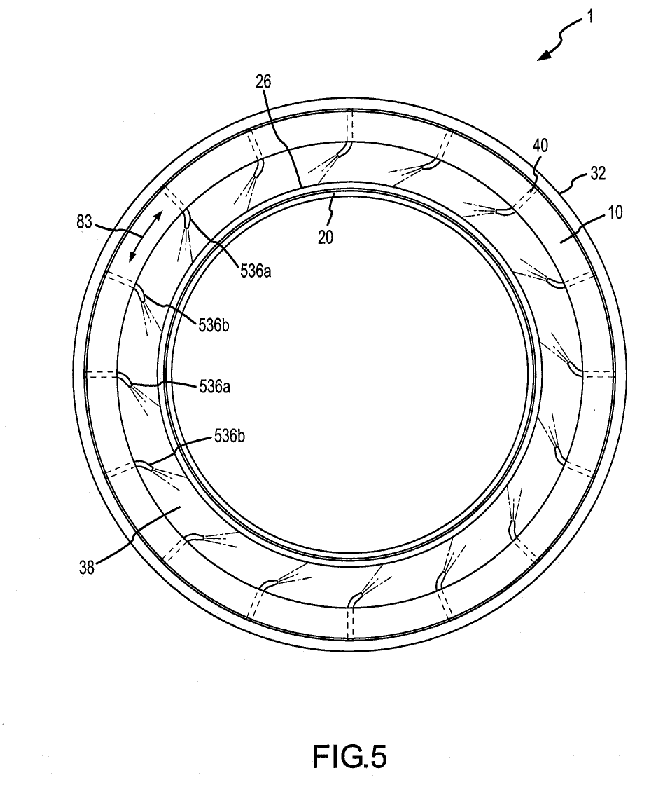

The nozzle(s) 36 may be of any shape that facilitates selective cooling of the sidewalls 20. For example, and with reference to FIG. 4a, the nozzle(s) 36 may comprise a narrow, elongated orientation and may be interconnected to the outer shell 10 at a substantially perpendicular orientation. In this embodiment, coolant discharged from the nozzle(s) 36 will have a discharge path that is substantially coincidental with the inlet path of the coolant, as indicated by arrows 400a. In an alternate embodiment, and with reference to FIG. 4b, the nozzle(s) 36 may comprise a fingerlike orientation to facilitate the selective distribution of the coolant. In this embodiment, the nozzle(s) 36 will have a discharge path that is transverse to the inlet path of the coolant, as indicated by arrows 400b. Thus, the nozzle(s) 36 may be operable to deliver the coolant in predefined trajectory relative to the sidewall 20.

One particular arrangement associated with the nozzles of FIG. 4b is illustrated in FIG. 5. In this embodiment, the electrolytic cell 1 includes a plurality of nozzles 536a, 536b dispersed about an internal perimeter of the outer shell 10, wherein the nozzles 536a, 536b comprise a fingerlike orientation. In one embodiment, one or more of such nozzles 536a, 536b are adapted for rotation about an axis to facilitate the selective delivery of the coolant. For example, one or more of these fingerlike nozzles 536a, 536b may be rotatable about an axis (e.g., rotatable over 45°, 90°, 180° or 360°, or portions thereof), wherein for each angle of rotation or portion thereof, a different discharge coolant path will be effected. A controller 60 may be interconnected to one or more of the nozzles 536a, 536b to effect movement thereof. Thus, the nozzle(s) 36 may be operable to deliver coolant in a selective and predefined trajectory and differing portions of the sidewall 20 may be selectively cooled. Such an arrangement may assist in reducing the number of nozzles required to operate the cell 1 and may further reduce the complexity of the control architecture involved with cooling operations. As discussed below, heat fins 26 may be interconnected to the sidewall 20 to assist cooling.

Referring back to FIG. 2, each of the nozzle(s) 36 may include one or more of the above-described embodiments/characteristics. For example, a first set of nozzles may comprise a first material of construction, a first size/shape, and/or a first orientation and a second set of nozzles may comprise a second material of construction, a second size/shape and/or a second orientation. Such first and second sets may be employed within an electrolytic cell 1 to suit the individual characteristics of such sets. By way of illustration, a first set of nozzles comprising relatively large, high flow rate nozzles may be utilized in a first portion of the cell (e.g., proximal a bottom portion of the cell), and a second set of nozzles comprising smaller, lower flow rate nozzles may be utilized in a second portion of the cell (e.g., proximal a top portion of the cell).

The nozzle(s) 36 may be dispersed throughout the electrolytic cell 1 as necessary to facilitate cooling operations. As noted above, the amount of nozzle(s) 36 and the spacing of the nozzle(s) 36 within the electrolytic cell 1 is dependent on various factors. In some instances, it may be desirable to uniformly space the nozzle(s) 36 about an internal perimeter of the outer wall 10, such as uniformly in the latitudinal and/or longitudinal directions relative to the interior perimeter of the outer shell 10. In such an embodiment, the amount of nozzle(s) 36 required to achieve desired cooling rates may be reduced. Likewise, the amount of coolant necessary to achieve the desired cooling rates may also be reduced. Moreover, in such an arrangement, coolant distribution relative to the sidewall will be at most partially overlapping, and in some instances, substantially non-overlapping. Thus, cooling rates of the various portions of the sidewall 20 may be selectively tailored per nozzle and/or nozzle set.

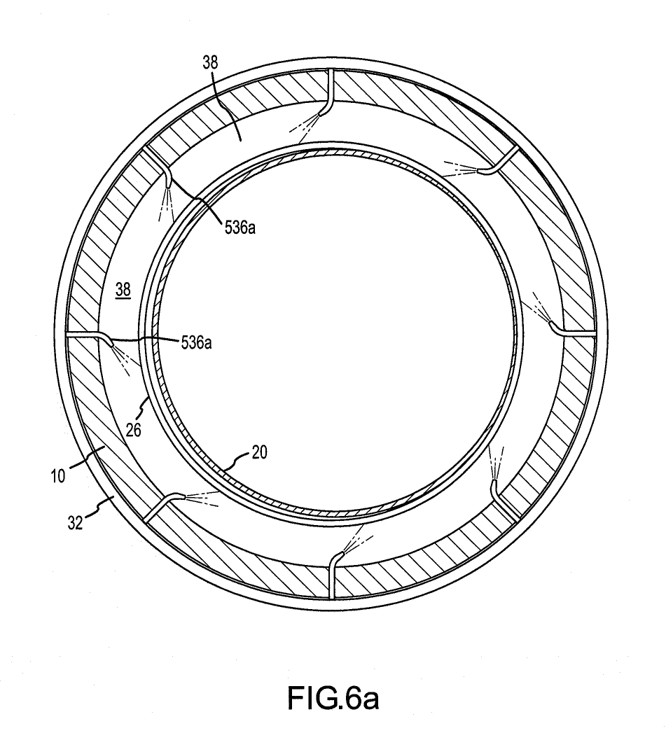

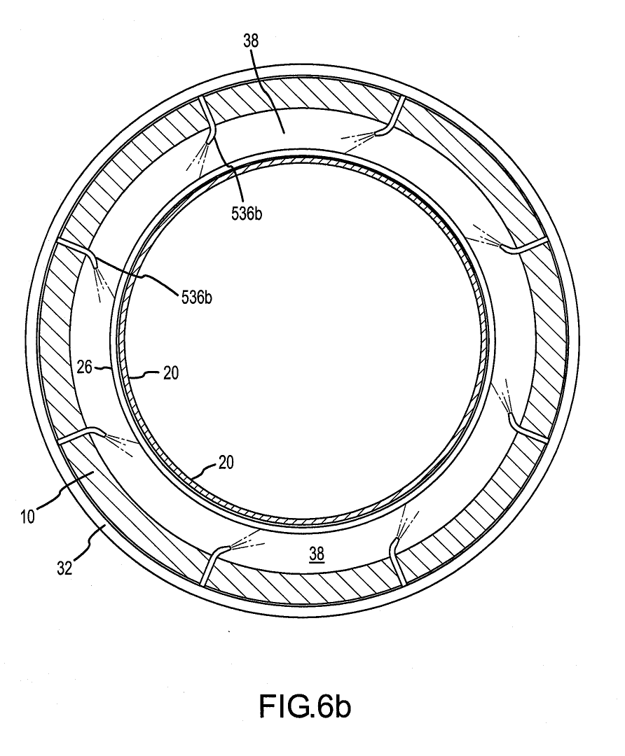

One nozzle(s) 36 arrangement is now described with reference to FIGS. 1, 5, 6a and 6b. In the illustrated embodiment, a first set of nozzles 536a is located in a first plane of the electrolytic cell 1 (e.g., a plane corresponding with the cross-section 6a) and a second set of nozzles 536b is located in a second plane of the electrolytic cell (e.g., a plane corresponding with the cross-section 6b). In other words, nozzles 536a are offset from nozzles 536b in a vertical direction 81 (FIG. 1), e.g., at different longitudinal positions of the interior perimeter of the outer shell 10. Thus, the first set of nozzles 536a may be able to cool a first selected portion of the sidewall 20 and the second set of nozzles 536b may be able to cool a second selected portion of the sidewall 20. In the illustrated embodiment, the first set of nozzles 536a are positioned to discharge coolant toward an upper portion of the sidewall 20 and the second set of nozzles 536b are positioned to discharge coolant toward a lower portion of the sidewall 20. In this embodiment, the first and second planes are substantially parallel to one another, the first and second planes are relatively horizontal and the first and second planes do not intersect one another.

In the illustrated embodiment of FIGS. 1, 5, 6a and 6b, the first set of nozzles 536a are also offset relative to the second set of nozzles 536b in a horizontal direction 83 (FIG. 5), such as at different latitudinal positions of the interior perimeter of outer shell 10. Hence, the first set of nozzles 536a may be adapted to provide coolant to first portions of the sidewall 20 and the second set of nozzles 536b are adapted to provide coolant to second portions of the sidewall 20, wherein the first and second sidewall portions are at most partially overlapping, and in some instances, substantially non-overlapping. Thus, cooling rates of the various portions of the sidewall 20 may be selectively tailored per nozzle and/or nozzle set. Moreover, coolant efficiency and effectiveness may be increased.

Other nozzle arrangements are also possible. For example, a first set of nozzles may be located in a first vertical plane and a second set of nozzles may be located in a second vertical plane. In this arrangement, the first and second vertical planes may be transverse to one another (e.g., in a cylindrical-style electrolytic cell) or the first and second vertical planes may be substantially parallel or perpendicular to one another (e.g., in a rectangular solid-style electrolytic cell). In this arrangement, the first set of nozzles may discharge coolant along a first longitudinal portion of the sidewall 20 and the second set of nozzles may discharge coolant along a second longitudinal portion of the sidewall 20.

As noted, the sidewall thermally interacts with the coolant from the nozzle(s) 36 to facilitate maintenance of ledge 8 profile. In this regard, the sidewall 20 should generally be adapted to facilitate thermal interaction between the coolant and the ledge 8. Thus, the sidewall 20 may include one or more metal layers adapted to promote heat transfer through the sidewall 20. The sidewall 20 should also be adapted to contain the molten bath and molten metal within the cell. Thus, the sidewall 20 generally comprises one or more impermeable layers adapted to contain the molten bath and molten metal.

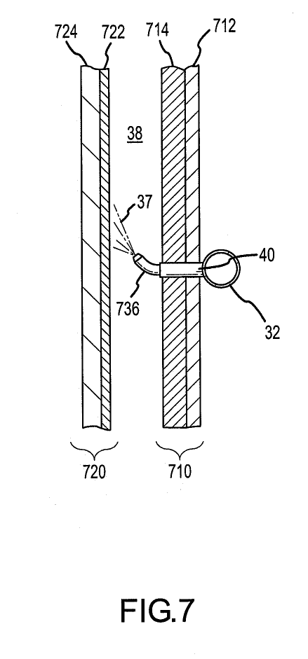

One particular sidewall embodiment is illustrated in FIG. 7. In this embodiment, the sidewall 720 includes a thermally conductive layer 722 (e.g., a metal layer) and a containment layer 724 (e.g., a refractory lining). In operation, coolant 37 from nozzle 736 contacts the thermally conductive layer 722, which is in thermal communication with the containment layer 724, thereby cooling the thermally conductive layer 722 and the containment layer 724. The thermally conductive layer 722 may be interconnected to the containment layer 724 by any suitable means, such as via an adhesive or mechanical means.

Any suitable thermally conductive material may be included in the thermally conductive layer 722, such as metal-containing materials. Likewise, any suitable containment material may be included in the containment layer 724. For example, in aluminum electrolysis cells, the thermally conductive layer 722 may comprise a nickel alloy, such as INCONEL and/or a steel material (e.g., stainless steel), and the containment layer 724 may comprise a castable refractory and corresponding refractory paper.

The outer shell may include any material(s) adapted to contain molten materials in case the sidewall ruptures. One outer shell useful in conjunction with the present invention is illustrated in FIG. 7. The outer shell 710 includes an insulative layer 714 and a containment layer 712. The insulative layer 714 should be adapted to inhibit thermal communication between fluids within the gap 38 and the containment layer 712. For example, the insulation layer 714 may include insulative materials such as calcium silicate boards (e.g., MARINITE, available from BNZ Netcrids, Inc., Littleton, Colo. U.S.A.) and compression glass materials (e.g., THERMALATE, available from Java Products, Middlefield, Ohio, U.S.A.). The containment layer 712 should be adapted to contain molten materials. Useful containment materials include steel materials. The insulative layer 714 may be interconnected to the containment layer 712 by any suitable means, such as via an adhesive or mechanical means.

Referring back to FIG. 2, the distance between the interior perimeter of the outer shell 10 and the exterior perimeter of the sidewall 20 (i.e., the gap size) is a function of various parameters, including coolant type, coolant flow rate, and operating temperature of the electrolysis cell, to name a few. For example, the gap size may be between 2 inches (˜5 centimeters) and 10 inches (˜25 centimeters) in aluminum electrolysis cells. The gap size may be uniform about electrolysis cell 1 or the gap size may vary to achieve the desired cooling rates. Moreover, the gap may be enclosed, such as using lid 7, or may be open to the surrounding atmosphere. If the gap is open, an outlet manifold 34 may not be necessary.

Referring now to FIGS. 2 and 5, heat fins 26 may be interconnected to the sidewall 20 to further facilitate thermal communication between coolant and the sidewall 20. Any number of heat fins 26 may be used and the heat fins 26 may be spaced in any useful manner about the exterior perimeter of the sidewall 20. For example, and with reference to FIG. 5, the heat fins 26 may be disposed about the exterior of the sidewall 20, such as circumferentially about an outer surface of the sidewall 20. The heat fins 26 may also be of any useful shape and orientation. In one embodiment, the heat fins 26 may also act to reinforce a thermally conductive layer of the sidewall 20, such as by binding the thermally conductive layer to a containment layer.

The coolant may be any coolant that will facilitate cooling of the sidewall 20. For example, gas phase coolants, such as air, nitrogen, carbon dioxide, or noble gases (e.g., helium) may be used. Liquid phase coolants, such as water, brines, glycols (e.g., propylene glycol, ethylene glycol), calcium chloride, potassium formate, cryogenic fluids, and/or fluorocarbon coolants may also /alternatively be used. The coolants may be pressurized or at atmospheric, or about atmospheric, pressure.

In one embodiment, the coolant comprises air distributed to the nozzle(s) 36 via inlet manifold 32. After use, the air may exit gap 38 to outlet manifold 34 via passageway 42. The outlet manifold 34 may be interconnected to a coolant reclamation system and/or a coolant disposal system (e.g., a vent). In one embodiment, the coolant reclamation system may comprise a heat exchanger. The heat exchanger may be utilized for many purposes, such as for heating water to steam, where the steam is utilized in a turbine application to generate electricity. The heat exchanger could also be used to supply hot air to residential customers for heating applications or cooling applications (e.g., air conditioning or heat pump applications).

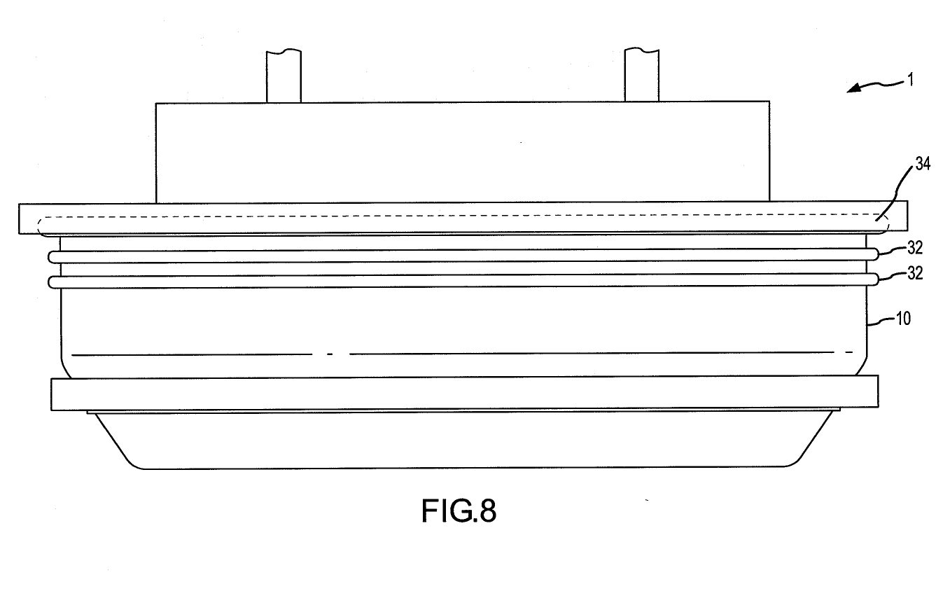

The inlet manifold 32 may be configured into any suitable manner to provide coolant to the nozzle(s) 36. For example, and with reference to FIG. 8, the inlet manifold 32 may be disposed about the outer shell 10 of the electrolysis cell 1 and may be fluidly interconnected to a coolant supply (not illustrated). The inlet manifold 32 may interconnect with the nozzle(s) 36 in any suitable manner, such as via individual manifolds, each interconnected to a coolant supply, or one continuous manifold (e.g., a manifold curved in a helical fashion and disposed about the outer perimeter of the outer shell 10) interconnected to a coolant supply. Likewise, the outlet manifold 34 may be interconnected to the gap 38 in any suitable manner to enable coolant to exit gap 38. For example, the outlet manifold 34 may wrap around the outer shell 10 of the electrolysis cell 1 and may be interconnected to a coolant disposal system and/or coolant reclamation system, as described above.

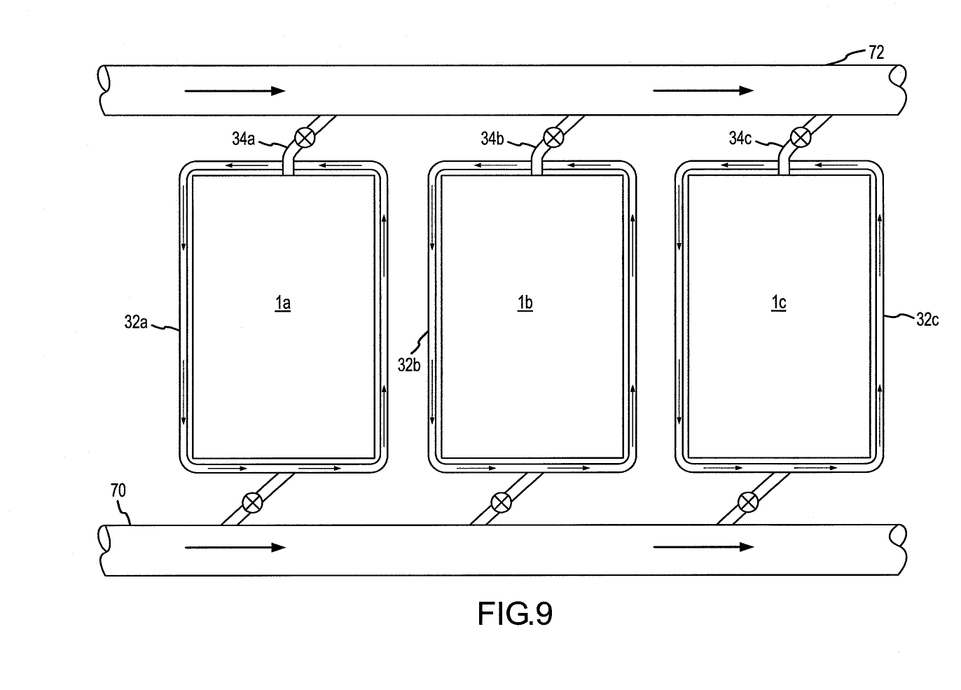

The coolant supply may be interconnected to a single electrolysis cell or a plurality of electrolysis cells. For example, and with reference to FIG. 9, a coolant supply (not illustrated) may be interconnected to a plurality of inlet manifolds 32a, 32b, 32c via supply pipe 70, each of which may be interconnected to individual electrolysis cells 1a, 1b, 1c. Likewise, the coolant disposal and/or coolant reclamation system may be interconnected to a plurality of electrolysis cells 1a, 1b, 1c. For example, and with continued reference to FIG. 9, a plurality of outlet manifolds 34a, 34b, 34c may be interconnected to a coolant return pipe 72. Thus, a single coolant supply system and/or coolant reclamation system and/or coolant disposal system may be utilized in conjunction with a plurality of electrolysis cells. Relatedly, a single controller, as described above, may be utilized to operate the nozzle(s) systems of the plurality of electrolysis cells.

In another arrangement, a simple passageway may be utilized to supply coolant to the gap 38. For example, the outer shell may include one or more passageways that fluidly interconnect the gap 38 to an exterior portion of the outer shell 10. Thus, air and/or other fluids located on the exterior of the outer shell 10 may be drawn into gap 38 via such passageways to provide further cooling (e.g., via convection forces from incoming coolant from the nozzles 36).

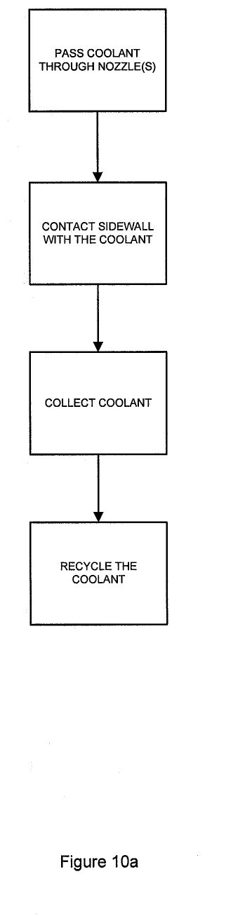

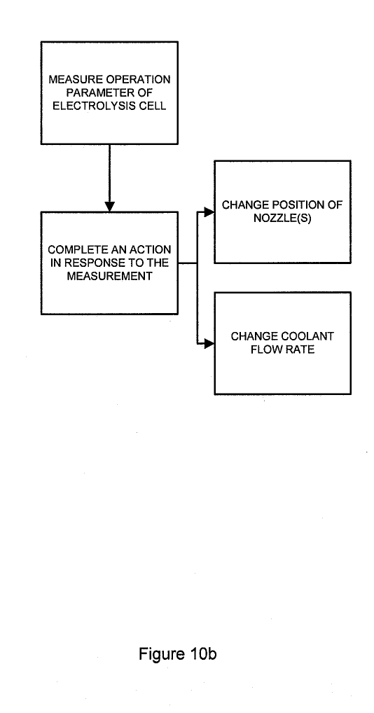

The present invention also relates to methods of cooling electrolysis cells. For example, and with reference to FIG. 10a, a method may include the step of passing coolant through the nozzle(s) and the step of contacting the sidewall 20 (e.g., the outer surface of the sidewall 20) with the coolant. The method may also include the optional step of collecting the coolant, such as after the coolant has been utilized to cool the sidewall, and the optional step of recycling the coolant, such as by flowing the coolant to a coolant reclamation system, as described above. The passing step may include additional steps, such as supplying coolant from a coolant supply to an inlet manifold, and/or flowing the coolant through a plurality of passageways to corresponding nozzle(s).

With reference to FIG. 10b, the method may include the step of measuring an operation parameter of the electrolysis cell, for example, one or more of a temperature measurement, a heat flux measurement and/or coolant flow rate measurement. The method may further include the step of completing an action, such as a pre-determined action, in response to the measuring step. For example, the position of the nozzle(s) may be changed in response to a high temperature and/or low heat flux measurement. The coolant flow rate through the nozzle(s) may also be changed in response to any one of the above referenced operations. Thus, the methods of the present invention are particularly adept at maintaining the ledge profile in electrolysis cells, such as aluminum electrolysis cells. As may be appreciated, any of the above-described nozzle(s), outer shell, and sidewall arrangements and embodiments may be utilized in conjunction with the inventive methods.

In view of the foregoing, it will be appreciated that the present invention provides sidewall cooling systems that greatly enhance the ability to control the temperature and thus the profile of the ledge. Moreover, the use of the dual wall system may greatly decreases the outside surface temperature of the electrolysis cell. Indeed, the gap between the sidewall and outer shell will not only serve to cool the sidewall, but the outer shell will generally be much cooler than in traditional electrolysis cells. For example, the outer surface of a traditional aluminum electrolysis cell can reach temperatures in excess of 200° C. With the present invention, the temperature of an outside portion of the outer shell may be well below 200° C., such as not greater than 100° C., even not greater than 75° C., or even not greater than 50° C. In some instances, the temperature of an outside portion of the outer shell may be not greater than 45° C. or even not greater than 40° C. Thus, substantial safety and operational environment advantages may be achieved.

It may be appreciated that, while the above embodiments have been described in reference to nozzles, jets may also be used in place of nozzles, as appropriate. Moreover, neither nozzles nor jets may be utilized in accordance with the present invention. For instances, coolant may be passed from an inlet manifold through one or more inlet passageways located in the outer shell, through the gap and to the sidewall without the use of a nozzle and/or jet. One or more outlet passageway(s) may be fluidly interconnected to the gap to receive the discharged coolant, the outlet passageway(s) being fluidly interconnectable to the exterior of the outer shell, a coolant reclamation system and/or or a coolant disposal system. The passageways may be in the form of an insert (e.g., a pipe), or may be integral with the outer shell (e.g., such as by drilling holes in the outer shell). As may be appreciated, a mixture of nozzles, jets and/or passageways may be use in accordance with the present invention.

It will be appreciated that, while the present invention has been described and depicted in relation to a cylindrical style electrolysis cell, other electrolysis cell arrangements may be used. For instance, the electrolysis cell may be of a rectangular solid configuration, wherein the outer shell comprises two opposing walls of the rectangular solid and end walls comprise the other two opposing walls of the rectangular solid. Two sidewalls may be disposed inside the cell relative to and coincidental with the two outer shell walls, thereby defining the gaps. Sidewalls may or may not be used coincidental with the end walls. Any of the above-described nozzle, manifold, and other features may be used in conjunction with this arrangement. In some instances, this rectangular solid electrolysis cell arrangement may be preferred relative to the cylindrical electrolysis cell arrangement. The cooling systems and methods of the present invention may be utilized with various electrolysis cells including, without limitation, aluminum, lead, magnesium, zinc, zirconium, titanium and silicon electrolysis cells.

While various approaches, aspects, embodiments and otherwise of the present invention have been described in detail, it is apparent that modifications and adaptations of those embodiments will occur to those skilled in the art. However, it is to be expressly understood that such modifications and adaptations are within the spirit and scope of present invention. Moreover, the use of directional and/or positional terms, such as upper, lower, middle, horizontal, vertical, exterior, interior, latitudinal, longitudinal, above and/or below, and the like, are for illustrative purposes and should not be construed as limiting the invention in any manner.

What is claimed is:

1. A method for selectively maintaining a profile of a ledge during operation of an electrolysis cell, the method comprising:
passing coolant through at least one fluid discharge device; and
contacting a portion of a sidewall of the electrolysis cell with the coolant.

2. The method of claim 1, further comprising:
discharging the coolant from the at least one fluid discharge device at a selected discharge trajectory.

3. The method of claim 2, further comprising:
changing the discharge trajectory.

4. The method of claim 3, wherein the changing comprises:
moving the at least one fluid discharge device.

5. The method of claim 4, wherein the moving comprises:
rotating the at least one fluid discharge device about an axis.

6. The method of claim 3, wherein the changing comprises:
sending a control signal to the at least one fluid discharge device.

7. The method of claim 6, wherein the control signal originates from a controller electrically interconnected to the at least one fluid discharge device.

8. The method of claim any of claim 1, further comprising:
measuring an operation parameter of the electrolytic cell; and
completing an action in response to the measuring step.

9. The method of claim 8, wherein the operation parameter comprises at least one of a temperature measurement, a heat flux measurement, and a coolant flow rate measurement.

10. The method of any of claims 8, wherein the completing step comprises:
changing a coolant flow rate associated with at least one fluid discharge device.

11. The method of any of claims 8, wherein the completing step comprises:
changing a position of the at least one fluid discharge device.
